(19) United States
(12) Patent Application Publication
(10) Pub. No.: US 2022/0000205 A1
(43) Pub. Date: Jan. 6, 2022

(54) RUCHING TAPE, TAPE SYSTEM, AND METHODS OF MAKING AND USING SAME

(71) Applicant: Marines Rodriguez, Norwalk, CT (US)

(72) Inventor: Marines Rodriguez, Norwalk, CT (US)

(21) Appl. No.: 17/482,039

(22) Filed: Sep. 22, 2021

Related U.S. Application Data
(62) Division of application No. 16/508,645, filed on Jul. 11, 2019.
(60) Provisional application No. 62/696,947, filed on Jul. 12, 2018.

(51) Int. Cl. A41H 9/00; C09J 7/40; C09J 7/38; D05B 35/08

(52) U.S. Cl. CPC A41H 9/00; D05B 35/08; C09J 7/38; C09J 7/403

(57) ABSTRACT

Disclosed herein is a ruching tape comprising a flexible elastic ruching strip having a back surface configured to removably adhere to a textile and a non-adhesive front surface, the ruching strip having a length, a width in the range of about 3-30 mm, a thickness in the range of 0.1 to 2 mm, and an elastic extensibility in a direction parallel to the length in the range of about 10 to about 300 percent when manually pulled by a user. Corresponding systems and methods also are disclosed.

### CROSS REFERENCE TO RELATED APPLICATIONS

This is a divisional of U.S. application Ser. No. 16/508,645 filed Jul. 11, 2019, which claims the benefit of US Provision Application No. 62/696,947 filed Jul. 12, 2018.

### BACKGROUND

This disclosure relates generally to clothing and more particularly to customized clothing.

It is known to ruche sections of clothing in order to achieve a desired aesthetically pleasing appearance. In some cases, ruched sections of fabric are formed using a flexible, inelastic, non-adhesive segment of tape that is sewn to a gathered section of the textile. In other cases, a non-adhesive tape is stitched to fabric as a sewing machine gathers the fabric.

It would be useful to develop a new and improved product and method for ruching a textile.

### SUMMARY

One embodiment described herein is ruching tape comprising a flexible elastic ruching strip including a back surface having an adhesive layer formed thereon that is configured to removably adhere to a textile and a non-adhesive front surface, the ruching strip having a length, a width in the range of about 3 mm to about 30 mm, and an elastic extensibility in a direction parallel to the length in the range of about 10 to about 100 percent when manually pulled by a user. The adhesive strength of the ruching strip is sufficiently strong to prevent full separation from a textile upon which the ruching strip is manually pressed by the user, and is sufficiently weak to permit manual removal by the user.

Another embodiment described herein is method of ruching a textile comprising obtaining a segment of a ruching tape comprising a flexible elastic ruching strip including a back surface having an adhesive layer formed thereon that is configured to removably adhere to a textile and a non-adhesive front surface, the ruching strip having a length, a width in the range of about 3 mm to about 30 mm, and an elastic extensibility in a direction parallel to the length in the range of about 10 to about 100 percent when manually pulled by a user, stretching the segment of ruching tape, placing the back surface of the segment of ruching tape on a textile, and releasing the segment of ruching tape, allowing the segment to contract and thereby gather a section of the textile.

Another embodiment is a system comprising a plurality of segments of the ruching tape described above. In some cases, the system further comprising a plurality of segments of protective backing removably adhered to the back surface of the plurality of segments of ruching tape when the ruching tape is not in use.

Yet another embodiment is an assembly comprising the ruching tape described above adhered to a textile.

### BRIEF DESCRIPTION OF THE DRAWINGS

FIG. 1 shows a top view of a first embodiment of a segment of ruching tape prior to use.

FIG. 2 shows a side view of the embodiment of FIG. 1.

FIG. 3 shows a top view of a second embodiment of a segment of ruching tape prior to use.

FIG. 4 is a side view schematically showing a third embodiment of ruching tape stored as a roll.

FIG. 5 is a side view schematically showing a ruched textile.

FIG. 6 is a photo showing a front view of a textile prior to adhesion of the ruching tape.

FIG. 7 is a photo showing a segment of ruching tape (with backing attached) proximate a textile.

FIG. 8 is a photo showing the inner side of a shirt that is ready for the application of ruching tape.

FIG. 9 is a photo showing the ruching tape segment of FIG. 7 (with backing attached) positioned on the inner side of the shirt shown in FIG. 8.

FIG. 10 is a photo showing the application of ruching tape to the shirt after stretching, using manual pressure.

FIG. 11 is a close-up view of the ruched section of the shirt after the tape has contracted.

FIG. 12 is a photo showing the ruched textile.

FIG. 13 is a photo of the textile after the ruching tape has been removed.

FIG. 14 is a photo of a shirt that has no ruching.

FIG. 15 is a photos of the shirt of FIG. 14 with multiple segments of ruching tape applied to its inner side in a vertical configuration.

### DETAILED DESCRIPTION

An apparatus and method are described herein that pertain to the ruching of textiles. The apparatus comprises a flexible elastic strip having a back surface having an adhesive layer formed thereon that is configured to removably adhere to a textile, and a non-adhesive front surface. In some cases, the adhesive strength of the strip is sufficient to prevent separation from a textile for a period of at least 24 hours when the strip is mounted to a gathered section of the textile. The ruching tape is removably adhered to a textile without the use of a sewing machine or hot iron.

In one embodiment, the flexible, elastic tape has adhesive on one side such that it can be stretched and removably adhered to a garment. When the tape contracts after being applied to the garment, it creates a ruffled or ruched effect. In embodiments, the adhesive strength of the strip is sufficiently strong to prevent separation from a textile when the strip is mounted to a gathered section of a textile, but weak enough that a user can manually remove the tape from the textile without damaging the textile. In many cases, the tape is adhered to the inner side of the textile.

In some instances, a pressure sensitive adhesive (PSA) may be utilized as the adhesive on the elastic strip. PSAs may be modified as to their tack and their peel. The tack is related to stickiness which is a function of the polymer backbone and molecular weight of the polymer. The peel strength is also related to the molecular weight, with higher molecular weight giving higher peel strength. The stickiness and peel strength are also related to the chemistry of substrate, the weave, and other characteristics of the fabric.

The peel test is annotated as a “180 degree” test where the material with the PSA is pulled back on itself from the adhered substrate and a measurement is taken in lbs./inch (Newtons/25 mm). These measurements are taken at 30 minute, 24 hour, and 1 week intervals as the PSA develops higher peel strength over time.

The tack test is a “Loop Tack” test (ASTM D6195) where a loop us made with the PSA coated material, the PSA on the outside of the loop of the coated material. The loop is placed in the top grip of a tensile testing machine such as an Instron or MTS machine. The bottom of the loop is brought in contact with the top of a 1 inch cube that is held in the bottom grip of the tensile testing machine. The peak or average force to remove the loop of PSA coated material from the 1 inch cube is recorded as the loop tack.

Table 1 shows the values for a high peel/high tack acrylic PSA. This type of PSA is considered to be “permanent”.

TABLE 1

| 180° PEEL | | | Loop Tack |
|---|---|---|---|
| lbs/in (N/25 mm) | | | lbs/in |
| 30 | 24 | 1 Wk | (N/25-mm) |
| Min | Hr | | |
| 2.0 | 4.0 | 5.3 | 3.0 |
| (8.9) | (17.8) | (23.6) | (13.4) |

Table 2 shows the values for a medium peel/medium tack acrylic PSA. This type of PSA is considered to be “removeable”.

TABLE 2

| 180° PEEL | | | Loop Track |
|---|---|---|---|
| lbs/in (N/25 mm) | | | lbs/in |
| 30 | 24 | 1 Wk | (N/25-mm) |
| Min | Hr | | |
| 02 | 0.8 | 0.6 | 1.1 |
| (0.9) | (3.6) | (2.7) | (4.9) |

Another factor for the adhesives is the static shear resistance of the adhesive. This is the ability of the adhesive to resist creep or slippage, especially important when the adhesive is expected to maintain adhesion and placement when the adhesive is placed under strain. This test is described in ASTM D 3654/D 3654 M Standard Test Method for Holding Power of Pressure-Sensitive Tapes. The measurement of the shear strength is done in units of hours where a weight is attached to the bottom of the material with the PSA coating while a prescribed area of the top end of the material is adhered to the substrate of interest, here the substrate being cotton, nylon, polyester, and similar woven textiles. The static shear is typically greater than 6 hours and up to 200 hours at standard temperature and pressure (STP).

In some cases, the chemistry of a PSA utilizes an acrylic backbone. Modifications of the polymer backbone with different monomers allow for modifications of the peel, stickiness, and shear. Non-limiting examples of polymers used to form PSA include poly 2-ethylhexyl acrylate, poly n-butyl acrylate, cis-polyisoprene, styrenic block copolymers, and silicones. These polymers may be waterborne emulsions, water borne colloid dispersions, solvent borne solutions, hot melt, and ultra violet (UV) cured polymers. In one reduction to practice, the preferred PSA layer comprises a solvent-based acrylic adhesive including a modified acrylic-based polymer hydrophobic adhesive composed primarily of relatively hydrophobic low glass transition temperature (T_{g}) acrylate monomers such as 2-ethylhexyl acrylate, and specifically avoiding the incorporation of relatively hydrophilic monomers such as vinyl acetate. The PSA compound is preferably without cross-linkers; though minimum amounts of cross linkers maybe possible in some compounds that would match the performance characteristics claimed. PSAs in general are viscoelastic, meaning part elastic (bounce back into shape) and part viscous (flowing). The storage and loss modulus in viscoelastic materials measures the stored energy, representing the elastic portion, and the energy dissipated as heat, representing the viscous portion. In the present invention the preferred adhesive has a storage modulus at room temperature of between 1.88×10⁴ Pa at 0.1885 Hz to 5.25×10⁵ Pa at 628 Hz with a loss modulus of between 1.29×10⁴ Pa at 0.1885 Hz to 5.08×10⁵ at 628 Hz and a Damping Factor between 0.685 at 0.1885 Hz to 0.966 at 628 Hz measured on films 20 mil thick and at 5% strain. Within the PSA industry, it is generally assumed that stronger more durable bonds are achieved through addition of crosslinking agents which raise the average molecular weight and increase the Storage Modulus.

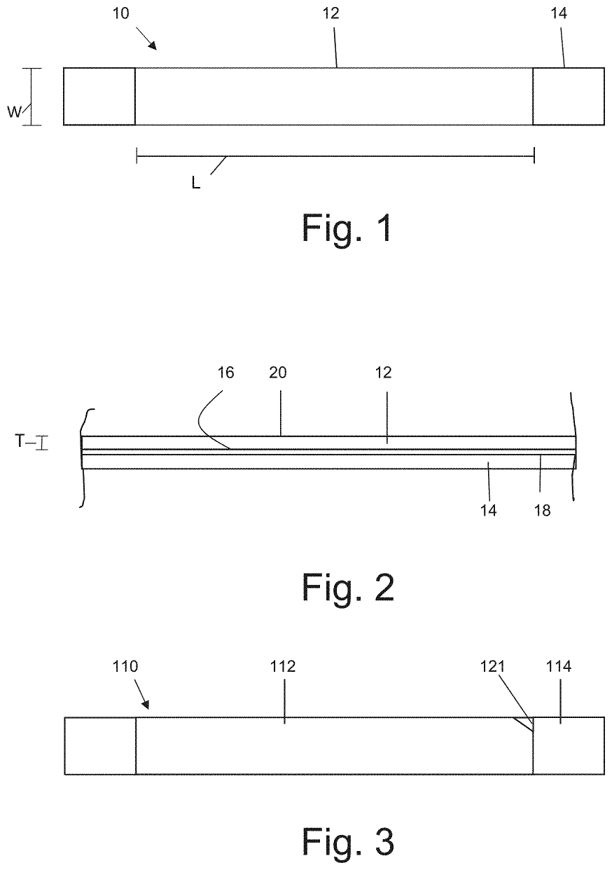

Referring to the drawings, FIGS. 1-2 show a segment of ruching tape adhered to a backing. The system including the tape and backing is generally designated as 10. The tape segment 12 is elongated, thin, flexible and elastically stretchable in the direction of its length. The tape segment has a length L, a width W and a thickness T. In embodiments, before stretching, the length of the tape segment without the backing is in the range of about 2.5 cm to about 30 cm, or about 5 cm to about 25 cm, or about 10 cm to about 15 cm. In embodiments, before stretching, the width of the tape segment 12 without the backing is in the range of about 3 mm to about 20 mm, or about 5 mm to about 15 mm, or about 7 mm to about 13 mm. In embodiments, before stretching, the thickness of the tape segment 12 is in the range of about 0.1 mm to about 2 mm, or about 0.2 mm to about 1 mm, or about 0.3 to about 0.8 mm. The tape segment 12 has a back surface 16 with an adhesive layer 18 formed thereon, and a front surface 20 that does not have an adhesive layer formed thereon.

The ruching tape has an elastic extensibility in a direction parallel to the length in the range of about 10% to about 300%, or about 20% to about 150%, or about 25% to about 75% when manually stretched by a user. In embodiments, the ruching tape is significantly extendable only in the direction of its length. In some embodiments, the width of the ruching tape decreases when the ruching tape is stretched in a lengthwise direction. In other embodiments, the width of the ruching tape remains substantially unchanged when the ruching tape is stretched in a lengthwise direction. The volume and thickness of the adhesive layer may depend in part upon the expected stretch of the tape when used. When greater stretching is applied, the adhesive layer is dispersed and thus larger quantities of adhesive may be required.

The ruching tape may be in a roll or in strips. The roll may be cut to the correct length for the specific application. The strips may be pre-cut to specific lengths to allow for specific ruching and ruffling effects.

In many embodiments, until the ruching tape 12 is to be used, it is removably mounted on backing strip 14. The backing strip 14 can be rigid or flexible, and has a sufficiently low surface tension to allow for the ruching tape 12 to be manually removed therefrom. In some cases, as is shown in FIG. 3, which depicts a system 110 with tape segment 112 and backing 114, an edge or corner of the ruching tape 112 includes a lift tab 121 configured to enable a user to easily place a portion of their finger, or a tool, between the lift tab 12 and the backing strip 14 in order to remove the ruching tape 12 from the backing 114. In embodiments, the lift tab 121 comprises a small section of the ruching tape 112 that does not have adhesive layer formed on the back thereof.

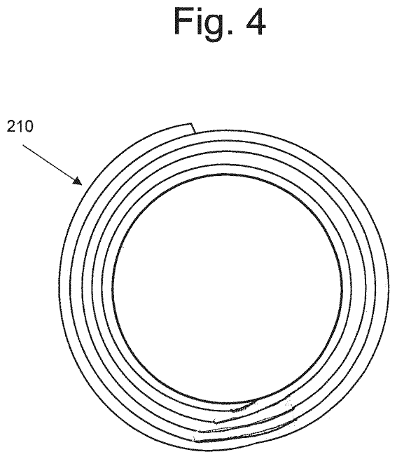

FIG. 4 shows a roll of a long, continuous length of system 210. In this embodiment, the user selects and cuts a desired length of ruching tape. If a lift tab is included in this type of system, it likely extends along the entire length of the ruching tape along an edge.

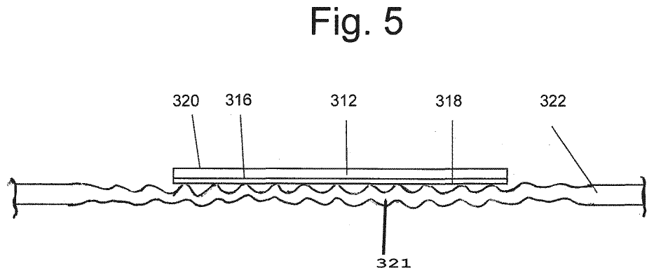

FIG. 5 schematically shows a side view of a ruched textile. The textile is designated as 322. The ruching tape 312 includes a non-adhesive front surface 320 and a back surface 316 having an adhesive layer 318 formed thereon. FIG. 5 shows the ruched section 321 of the textile beneath the ruching tape 312.

In embodiments, as indicated above, the adhesive is a pressure activatable adhesive, also referred to as a pressure sensitive adhesive (PSA). In some cases, the pressure activatable adhesive is activated by manual pressure by a user. In embodiments, the adhesive is a moisture-activatable adhesive.

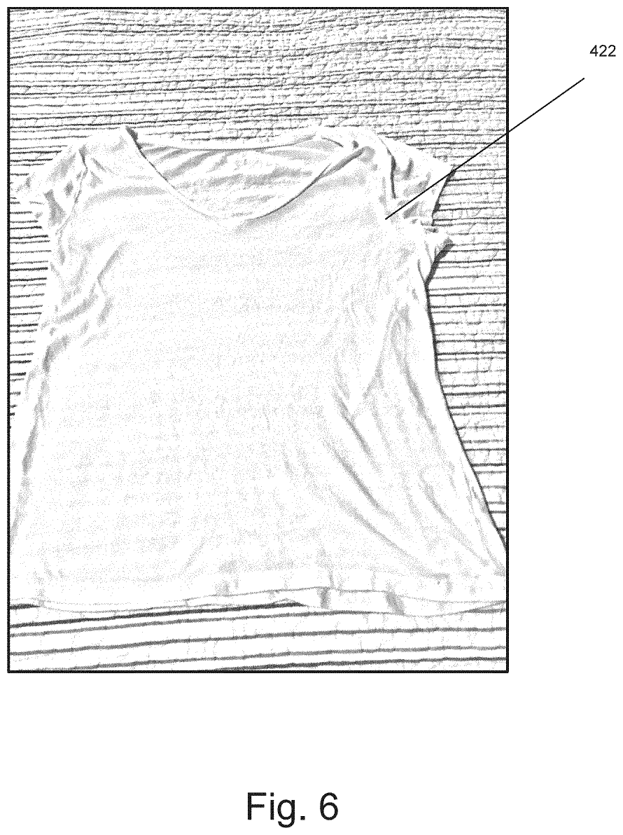

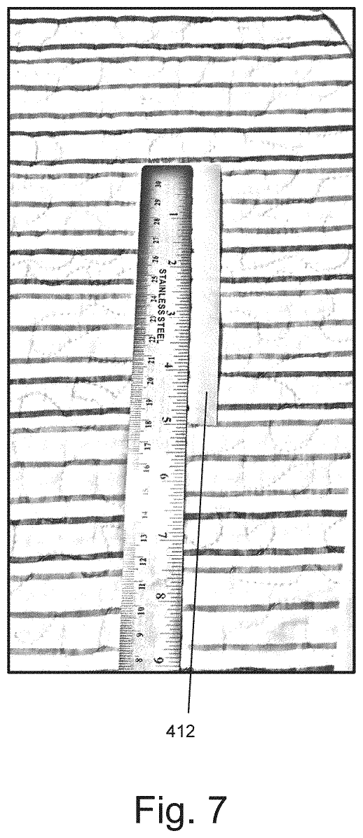

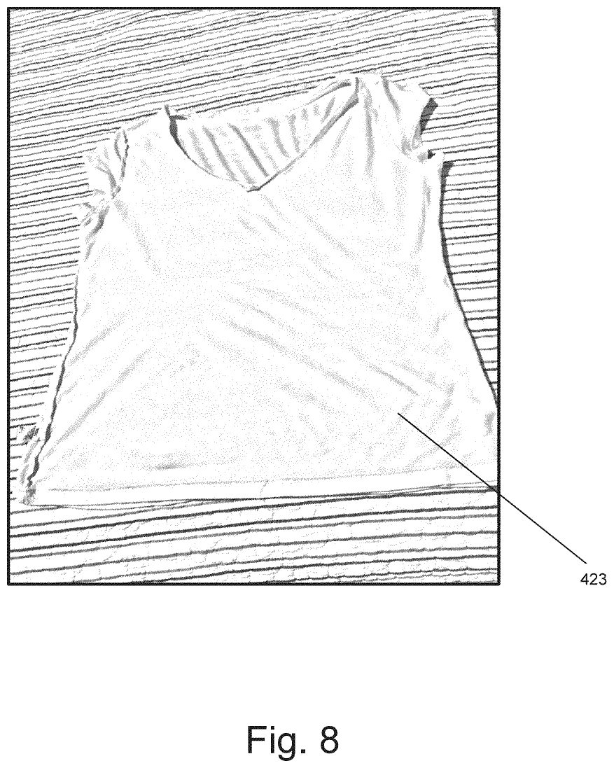

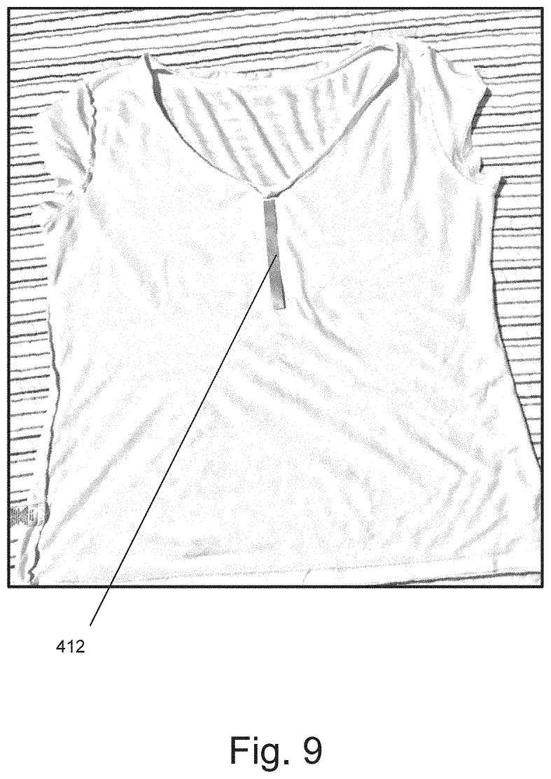

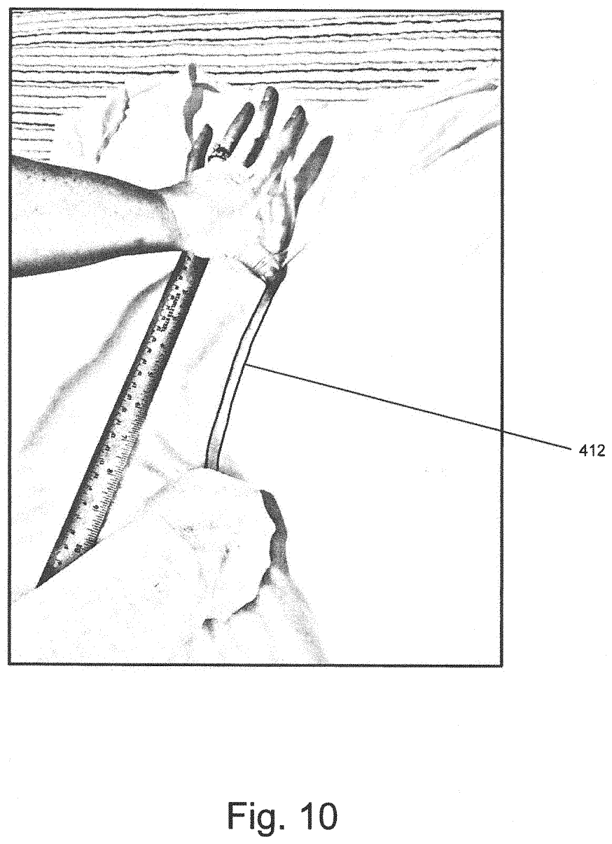

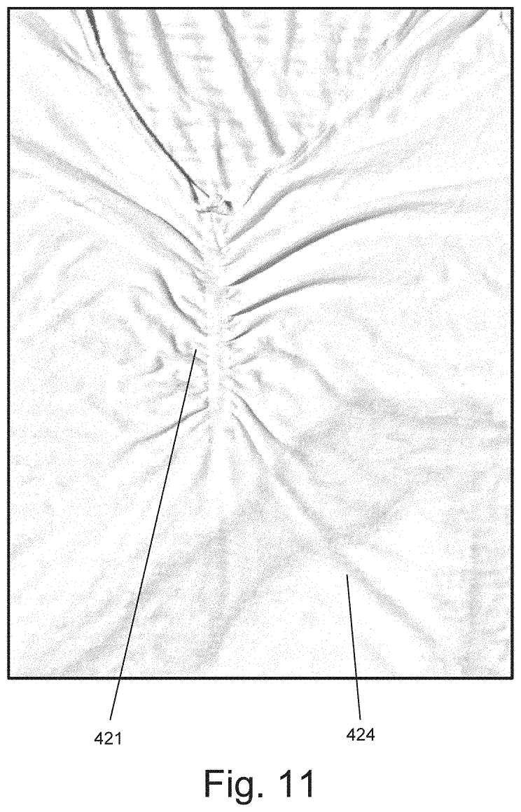

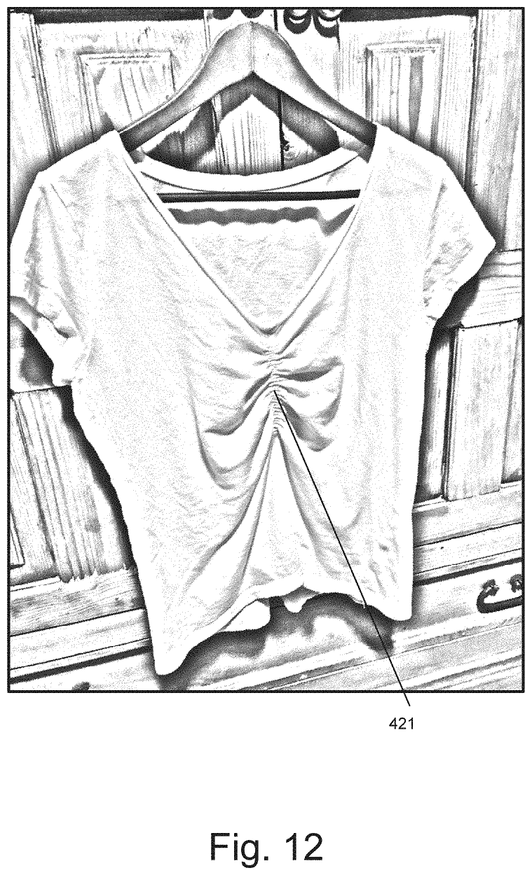

FIGS. 6-13 show various stages of a method of ruching a textile. A shirt with no ruching is shown in FIG. 6. A segment 412 of ruching tape of a desired length is obtained. FIG. 7 shows a 5 inch segment. The ruching tape has an adhesive layer formed on its back surface, and does not have an adhesive layer on its front surface. A backing covers the adhesive layer in the version shown in FIG. 7. (In embodiments in which a backing is used, one of the steps of the method comprises removing the segment of ruching tape from the backing.) The shirt is tuned inside out, as is shown in FIG. 8. Optionally, the tape segment 412 with the backing still attached is temporarily placed on the textile at the proposed location of use, as is shown in FIG. 9. The ruching tape 412 is stretched in a lengthwise direction such that its stretched length is 110%-300% of its unstretched length. In FIG. 10, the 5 inch segment of tape (after removal of the backing) is stretched to a length of about 7 inches, i.e. an increase in length of about 40%. The stretched ruching tape is then pressed onto the inner side 423 of the textile 422 using manual pressure or another suitable non-heated pressure technique. The ruching tape 412 is then released in order to allow contraction. The contracted ruching tape 412 produces a ruched portion 421 on the textile 422. FIG. 11 shows a close-up view of the outer side 424 of the ruched textile 422. FIG. 12 shows the outer side 424 of substantially the entire ruched textile 422, which is a shirt. In some cases, after stretching, the ruching tape contracts to its original length. In other cases, the stretched tape contracts to a length that is about 3% to about 20% longer than its original length, or about 5% to about 10% longer than its original length.

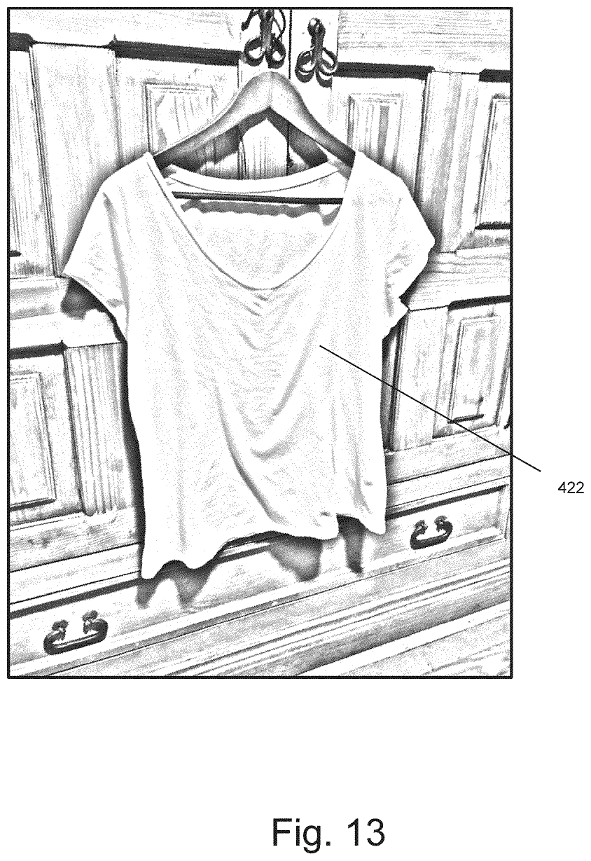

FIG. 13 shows a shirt after the ruching tape has been removed and before washing. There is minimal evidence in the photo that the front of the shirt used to be ruched with the removable ruching tape.

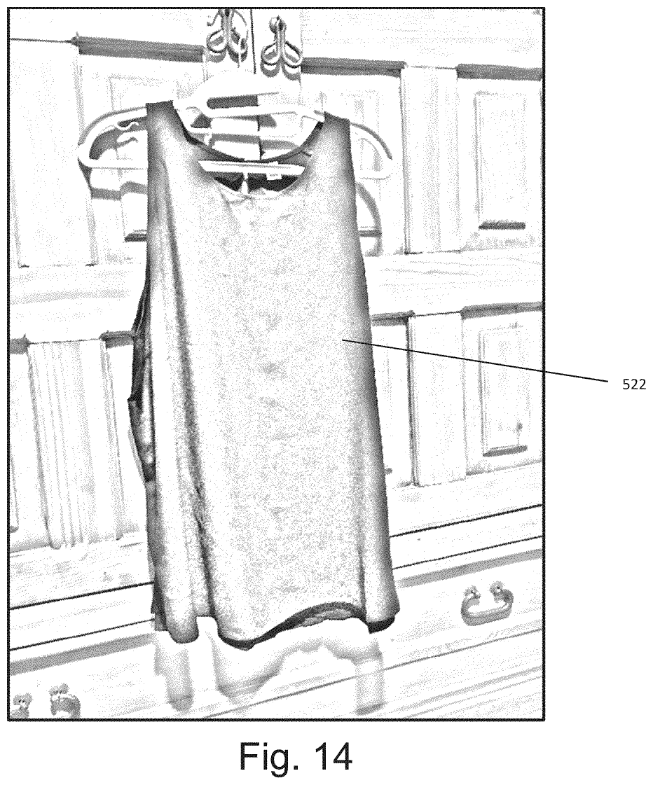

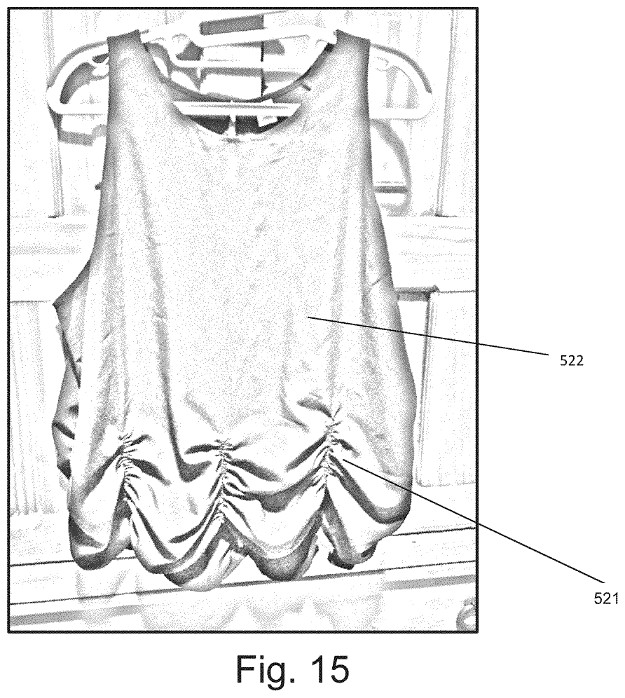

FIG. 14 shows a second shirt 522 with no ruching. FIG. 15 shows the shirt of FIG. 14 having 8 segments of ruching tape applied on its inner side forming eight ruched portions 521, in order to give the shirt a dressier look.

In embodiments the ruching tape comprises an elastic thermoplastic or thermoset material including at least one member selected from the group consisting of thermoplastic elastomers, including thermoplastic polyurethanes and thermoplastic polyolefin elastomers. Non-limiting examples of commercially available thermoplastic polyurethanes include Mobilon thermoplastic polyurethanes (Nisshinbo Chemical), PELLETHANE thermoplastic polyurethanes (DowDuPont), ELASTOLLAN thermoplastic polyurethanes (BASF), and MIRACTRAN thermoplastic polyurethanes (Nippon Miractran). The adhesive usually is a pressure-sensitive adhesive. In embodiments, the adhesive is a solid. The adhesive layer does not require heat in order to adhere to a textile. In some cases, the amount of pressure required to adhere the stretched ruching tape is about the same pressure needed to seal an envelope having a pressure-activated adhesive formed thereon. Non-limiting examples of pressure-activatable adhesives include elastomers mixed with a tackifier, such as a rosin ester, or an elastomer that is inherently tacky, such as acrylic materials. The adhesive can be bound to the tape using surface treatment, heating or UV curing, etc.

When a backing is used before the ruching tape is to be applied to a textile, the backing can comprise a material that contains a release agent, such as silicone.

The ruching tape is suitable for use with a variety of textiles, including but not limited to cotton, polyester, rayon, silk, satin, and combinations thereof. In embodiments, the fabric is knit or woven.

A number of alternatives, modifications, variations, or improvements therein may be subsequently made by those skilled in the art, which are also intended to be encompassed by the following claims.

What is claimed is:

1. A method of ruching a textile, comprising:
obtaining a segment of a ruching tape comprising a flexible elastic ruching strip having a back surface with an adhesive layer formed thereon that is configured to adhere to a textile and a non-adhesive front surface, the ruching strip having a length, a width in the range of about 3-30 mm, a thickness in the range of 0.1 to 2 mm and an extensibility in a direction parallel to the length in the range of about 10 to about 300 percent when manually pulled by a user,
stretching the segment of ruching tape,
placing the back surface of the segment of ruching tape on a textile, and
releasing the segment of ruching tape, allowing the segment to contract and thereby gather a section of the textile.

2. The method of claim 1, wherein the adhesive strength of the ruching strip is sufficient to prevent separation from the textile for a period of at least 24 hours when the ruching strip is mounted to the gathered section of the textile.

3. The method of claim 1, further comprising, prior to stretching, cutting the segment to a length under 6 inches.

4. The method of claim 3, wherein the flexible elastic ruching strip has a non-adhesive backing formed on the adhesive layer and after cutting,
peeling off the adhesive strip from the non-adhesive side of the segment.

5. The method of claim 1, wherein the step of obtaining the ruching tape comprises cutting a segment from a roll of ruching tape.

6. The method of claim 1, wherein the segment of ruching tape has a loop tack in the range 1.1-3.0 n/25 mm (ASTM D6195).

7. The method of claim 1, wherein the step of placing includes pressing onto the surface of the textile to sufficiently attach the segment onto the textile.

8. The method of claim 7, further comprising turning the textile inside out prior to pressing onto the surface of the textile.
